(19) United States
(12) Patent Application Publication
(10) Pub. No.: US 2015/0116760 A1
(43) Pub. Date: Apr. 30, 2015

(54) IMAGE FORMING DEVICE OPERATING WITH OTHER IMAGE FORMING DEVICE, IMAGE FORMING SYSTEM INCLUDING THE IMAGE FORMING DEVICE, MOBILE DEVICE TO USE THE IMAGE FORMING DEVICE AND METHOD OF CONTROLLING THE IMAGE FORMING DEVICE

(71) Applicant: Samsung Electronics Co., Ltd, Suwon-si (KR)

(72) Inventor: Jeong-sang KIM, Suwon-si (KR)

(73) Assignee: Samsung Electronics Co., Ltd, Suwon-si (KR)

(21) Appl. No.: 14/333,786

(22) Filed: Jul. 17, 2014

(30) Foreign Application Priority Data
Oct. 30, 2013 (KR) 10-2013-0129889

(51) Int. Cl. H04N 1/00

(52) U.S. Cl. CPC H04N 1/00493; H04N 1/00419; H04N 1/00424; H04N 1/00474; H04N 1/00315; H04N 1/00278; H04N 2201/0081; H04N 2201/0094; H04N 2201/0082; H04N 2201/0096; H04N 2201/0075; H04N 2201/0055
USPC 358/1.15

(57) ABSTRACT

A mobile device includes a communication unit configured to communicate with a plurality of image forming devices, a user interface (UI) processor configured to, when communication with a first image forming device that is one of the plurality of image forming devices is performed, display a local UI of the first image forming device, and a controller configured to, when a second image forming device which is connectable to the first image forming device is selected from the local UI, generate an additional function which is providable when the first image forming device and the second image forming device operate with each other, and control the UI processor to display a virtual UI including an additional menu object corresponding to the additional function.

### CROSS-REFERENCE TO RELATED APPLICATIONS

This application claims priority under 35 U.S.C. §119 from Korean Patent Application No. 10-2013-0129889, filed on Oct. 30, 2013 in the Korean Intellectual Property Office, the disclosure of which is incorporated herein by reference in its entirety.

### BACKGROUND OF THE INVENTION

1. Field of the Invention

The present general inventive concept generally relates to an image forming device operating with other image forming device, an image forming system including the image forming device, and a method of controlling the image forming device.

2. Description of the Related Art

With the improvement of electronic technologies, the distribution rate of computers has been greatly increased. As a result, use of various peripherals for computers has been greatly increased as well. As a typical example, there may be image forming devices such as scanners, printers, copy machines, multifunctional devices, etc.

Home users commonly use an image forming device which is connected to a Personal Computer (PC) through a local network, while in office environments such as a company, a business office, and a research institute, it is common to use a plurality of image forming devices which are connected through a network.

Meanwhile, an image forming device may support various functions according to a hardware specification and a software specification thereof. Accordingly, a user who wishes to use a particular function should find an image forming device providing the function first. However, it is not easy to find a particular image forming device providing a desired function in a network environment where many image forming devices are connected.

Furthermore, even when there are several image forming devices on a network, the image forming device providing the desired function may not exist among the image forming devices on the network. In this case, the user may be able to interwork the image forming devices to execute the desired function. For example, when the user wishes to copy a document in a system environment in which a scanner and a printer are equipped, the user should scan the document first by using the scanner, and transmit the scanned document to the printer in order to output the document. However, this is a complicated operation requiring that the user conduct separate tasks at the separate image forming devices.

Accordingly, a necessity of a method to use an image forming device more easily and effectively in an environment where a plurality of image forming devices exist has been raised.

### SUMMARY OF THE INVENTION

The present general inventive concept provides an image forming device operating with one or more other image forming devices, an image forming system including the image forming device, a mobile device to use the image forming device, and a method of controlling the image forming device.

Additional features and utilities of the present general inventive concept will be set forth in part in the description which follows and, in part, will be obvious from the description, or may be learned by practice of the general inventive concept.

Exemplary embodiments of the present general inventive concept provide a mobile device including a communication unit configured to communicate with a plurality of image forming devices, a user interface (UI) processor configured to, when communication with a first image forming device that is one of the plurality of image forming devices is performed, display a local UI of the first image forming device, and a controller configured to, when a second image forming device which is connectable to the first image forming device is selected from the local UI, generate an additional function which is providable when the first image forming device and the second image forming device operate with each other, and control the UI processor to display a virtual UI including an additional menu object corresponding to the additional function.

When the additional menu object is selected from the virtual UI, the controller may execute the additional function by transmitting a control signal to each of the first image forming device and the second image forming device.

The local UI may include a local menu object corresponding to a function which is autonomously providable by the first image forming device and a list of other image forming devices which are connectable to the first image forming device.

When the second image forming device is selected from among the other image forming devices included in the list, the controller may request capability information, status information, and error information from the second image forming device.

The list may include icons corresponding to each of the other image forming devices. When the capability information, the status information, and the error information are received from the second image forming device, the UI processor may display a message corresponding to at least one of the capability information, the status information, and the error information while toggling the message with the corresponding icon.

The communication unit may include a first communication unit configured to perform near field frequency communication, and a second communication unit. When the near field frequency communication between the first communication unit and the first image forming device is performed and UI information on the first image forming device is received, the controller may control the UI processor to generate the local UI according to the UI information, and when the second image forming device is selected from the list, request the capability information, the status information, and the error information to the second image forming device by using the second communication unit.

Exemplary embodiments of the present general inventive concept also provide a method of controlling an image forming device connected to a mobile device, the method including when communication with a first image forming device that is one of a plurality of image forming devices is performed, displaying a local UI of the first image forming device, when a second image forming device which is connectable to the first image forming device is selected from the local UI, generating an additional function which is providable when the first image forming device and the second image forming device operate with each other, and displaying a virtual UI including an additional menu object corresponding to the additional function.

The method may further include, when the additional menu object is selected from the virtual UI, executing the additional function by transmitting a control signal to each of the first image forming device and the second image forming device.

The local UI may include a local menu corresponding to a function which is autonomously providable by the first image forming device and a list of other image forming devices which are connectable to the first image forming device.

When the second image forming device is selected from among the other image forming devices included in the list, the displaying the virtual UI may include generating the virtual UI based on the capability information, the status information, and the error information of the second image forming device, and displaying the generated virtual UI.

The list may include icons corresponding to each of the other image forming devices. The method may further include displaying a message corresponding to at least one of the capability information, the status information, and the error information in the local UI while toggling the message with the corresponding icon.

The method may further include, when near field frequency communication with the first image forming device is performed and UI information on the first image forming device is received, generating the local UI according to the UI information.

A non-transitory computer-readable medium may contain computer-readable codes as a program to execute the method.

Exemplary embodiments of the present general inventive concept also provide an image forming device including a communication unit configured to communicate with at least one external device, and a user interface (UI) processor configured to display a local UI of the image forming device on a screen of a display unit, the local UI including at least one menu object corresponding to a function of the image forming device, and to display a virtual UI to replace the local UI when the image forming device is connected to the at least one external device, the virtual UI including at least one additional menu object corresponding to at least one additional function of the image forming device, the at least one additional function being providable when the image forming device is connected to the at least one external device.

The at least one external device may be a second image forming device.

The at least one external device may be a plurality of image forming devices.

The image forming device may be a mobile device, the local UI may correspond to a first external device, and the virtual UI may correspond to a second external device.

The mobile device may communicate directly with the first external device and the second external device.

The image forming device may communicate directly with the first external device and communicate with the second external device through the first external device.

The UI processor may display a list of external devices connectable to the image forming device when a user input to perform an image forming job is made on the local UI.

The image forming device may further include a controller to download an application corresponding to the one or more additional functions from the at least one external device.

Exemplary embodiments of the present general inventive concept also provide a method of controlling an image forming device, the method including displaying a local user interface (UI) of the image forming device on a screen of a display unit, the local UI including at least one menu object corresponding to a function of the image forming device, and displaying a virtual UI to replace the local UI when the image forming device is connected to at least one external device, the virtual UI including at least one additional menu object corresponding to at least one additional function of the image forming device, the at least one additional function being providable when the image forming device is connected to the at least one external device.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a diagram illustrating a structure of an image forming system according to an exemplary embodiment of the present general inventive concept;

FIG. 2 is a block diagram illustrating a structure of a mobile device according to an exemplary embodiment of the present general inventive concept;

FIGS. 3 and 4 are diagrams illustrating a local UI provided by each image forming device;

FIG. 5 is a diagram illustrating an example of a virtual UI for interworking and controlling a plurality of image forming devices;

FIG. 6 is a diagram illustrating an example of a UI configuration which is displayed in a mobile device;

FIG. 7 is a flow chart describing a method of controlling an image forming device of a mobile device according to an exemplary embodiment of the present general inventive concept;

FIG. 8 is a timing diagram describing operations of an image forming system according to an exemplary embodiment of the present general inventive concept;

FIG. 9 is a diagram describing a structure of an image forming system according to another exemplary embodiment of the present general inventive concept;

FIG. 10 is a diagram describing a change of a local UI according to a connection relation of an image forming device;

FIG. 11 is a block diagram illustrating a structure of an image forming device according to an exemplary embodiment of the present general inventive concept;

FIG. 12 is a flow chart describing a method to display a UI of an image forming device according to an exemplary embodiment of the present general inventive concept; and

FIG. 13 is a block diagram describing specific configurations of an image forming device which is embodied as a multifunctional device.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of exemplary embodiments. However, exemplary embodiments of the present general inventive concept can be practiced without those specifically defined matters. Also, well-known functions or constructions are not described in detail since they would obscure the application with unnecessary detail.

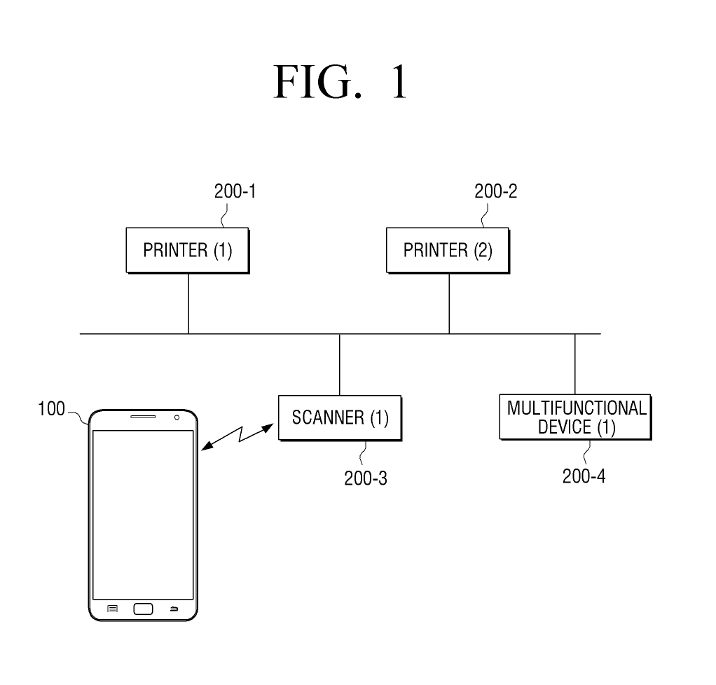

FIG. 1 is a diagram illustrating a structure of an image forming system according to an exemplary embodiment of the present general inventive concept. According to FIG. 1, the image forming system includes a plurality of image forming devices 200 (200-1 to 200-4) which are connected to each other through a network. Although FIG. 1 illustrates two printers as first and second image forming devices 200-1 and 200-2, a scanner as a third image forming device 200-3, and a multifunctional device as a fourth image forming device 200-4, these are only provided as examples. A type and number of the image forming devices is not limited thereto.

Although not illustrated in FIG. 1, the image forming system may further include a host PC which is connected to each of the plurality of image forming devices 200-1 to 200-4 through a local network or a network interface. A user is able to use each image forming device 200 by using the host PC or a mobile device 100. The host PC or the mobile device 100 may communicate with the image forming devices 200-1 to 200-4 using a wired or wireless communication method, including for example a Universal Serial Bus (USB) connection, a local area network (LAN), Wi-Fi, Bluetooth, Near Field Communication (NFC), or a wireless access point (AP), depending on the particular capabilities of the host PC or mobile device 100. The mobile device 100 may be embodied as for example a mobile phone, a laptop PC, a Personal Digital Assistant (PDA), an MP3 Player, etc. The mobile device 100 may also be embodied for example as a smart phone or a tablet PC including a display unit such as a touchscreen, usable as an output unit and an input unit. The mobile device 100 may receive a user's touch, gesture, audio signal, or other input through the display unit or other appropriate input unit, depending on the particular embodiment of the present general inventive concept.

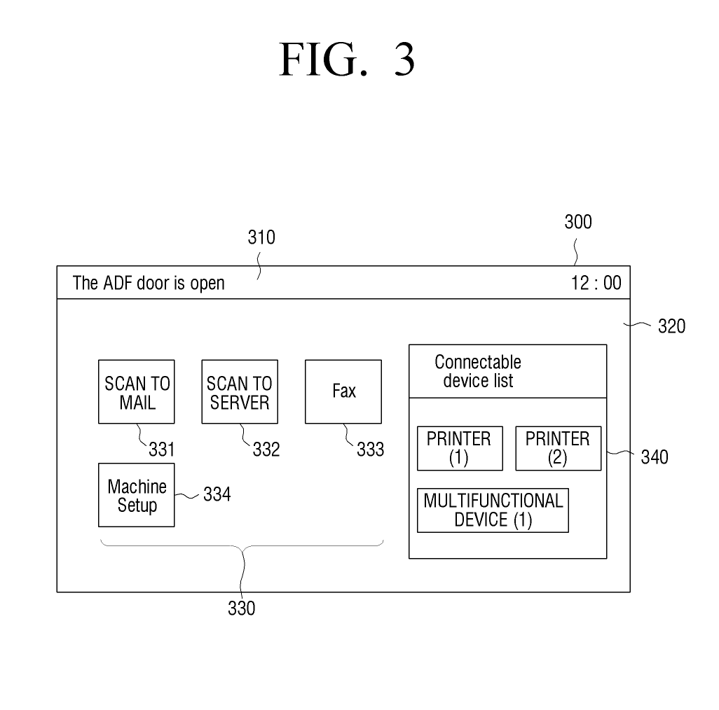

For example, when communication is performed between one of the plurality of image forming devices 200 and the mobile device 100, the mobile device 100 displays a local UI 300 (illustrated in FIG. 3) of the image forming device 200. The local UI 300 may display a local menu 330 (illustrated in FIG. 3) including menu objects corresponding to functions which may be provided by the image forming device 200 autonomously. In addition, the local UI 300 may further display information on other image forming devices which may be connected to the image forming device 200.

A user is able to select one of the other image forming devices 200 within the local UI 300.

Hereinafter, an image forming device 200 which communicates with the mobile device first is called a first image forming device 200-1, and an image forming device 200 which is selected through a local UI 300 of the first image forming device 200-1 is called a second image forming device 200-2 for convenience in explanation.

As specified above, when the second image forming device 200-2 is selected, the mobile device 100 generates an additional function which may be provided when the selected other image forming device 200 operates with the first image forming device 200-1.

The mobile device 100 may communicate with each image forming device 200 in various communication methods. As an example, the mobile device 100 may perform communication in a near field frequency communication method. According to an exemplary embodiment of using the near field frequency communication method, a user may tag the mobile device 100 that the user has with one of the image forming devices 200-1 to 200-4. Tagging refers to an action of brings the mobile device 100 close to an image forming device 200. When the mobile device 100 including a near field communication chip is tagged with an image forming device 200 including a near field communication chip, near field frequency communication is performed between the mobile device 100 and the image forming device 200.

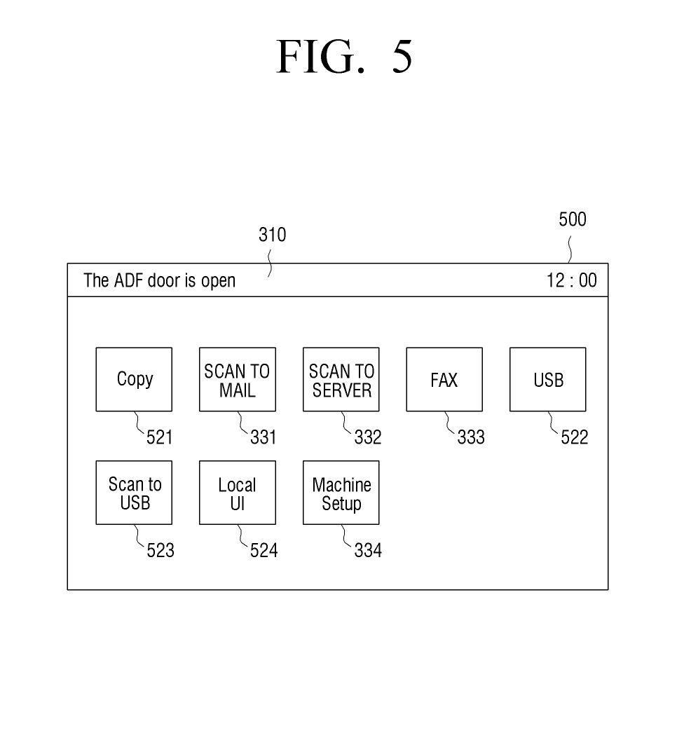

FIG. 1 illustrates a status where the mobile device 100 is tagged with the scanner 200-3. When the tagging is performed, the mobile device 100 may receive UI information from the scanner 200-3 though the near field frequency communication. The mobile device 100 displays a local UI 300 corresponding to the scanner 200-3 by using the received UI information. When the second image forming device 200-2 which is connectable to the scanner 200-3 is selected from the local UI 300, the mobile device 100 generates an additional function which may be provided when the scanner 200-3, that is, the first image forming device 200-1 operates with the selected second image forming device 200-2. In addition, the mobile device 100 displays a virtual UI 500 (illustrated in FIG. 5) including an additional menu object corresponding to the generated additional function.

The mobile device 100 may configure a local UI 300 and a virtual UI 500 based on status information, error information, and capability information which are provided by the first image forming device 200-1 or the second image forming device 200-2.

The status information refers to information regarding an operation status of each device. For example, various status information regarding an execution status of a job such as scanning and printing, a warm-up status, an idle status, a cover open status, a turn-off status and the like may be provided to the mobile device 100, and from there may be displayed to inform a user of the mobile device 100 of the status information. The error information refers to information regarding an error status of each device. For example, the error information may be a type of error which makes an image forming job inexecutable, such as a jam status, a paper run-out status, a toner run-out status, etc. The capability information refers to information regarding a function which may be provided by an image forming device 200 or hardware of the image forming device 200. For example, in the case of a scanner, there may be a scanner capable of scanning A3 size paper, a scanner having a Reversing Automatic Document Feeder (RADF), and a scanner having only a flatbed scanning unit. In the case of a printer, there may be a printer capable of scanning or printing on A3 size paper or other special papers, a printer supporting black-and-white printing only, a printer supporting color printing, a printer having a manual feed tray, a printer having a facsimile unit or a finisher unit, etc. The capability information may be generated in order to inform the mobile device 100 of the hardware or function of an image forming device 200.

Configuration examples of the local UI 300 and the virtual UI 500 will be described below in further detail.

A user is able to interwork a plurality of image forming devices 200 by selecting an additional menu object displayed on a virtual UI 500. That is, when the additional menu object is selected from the virtual UI 500, the mobile device 100 transmits a control signal corresponding to the selected additional menu object to the first image forming device 200-1 and the second image forming device 200-2 respectively. By doing so, the user is able to use a new function that may not be provided by solely the first image forming device 200-1.

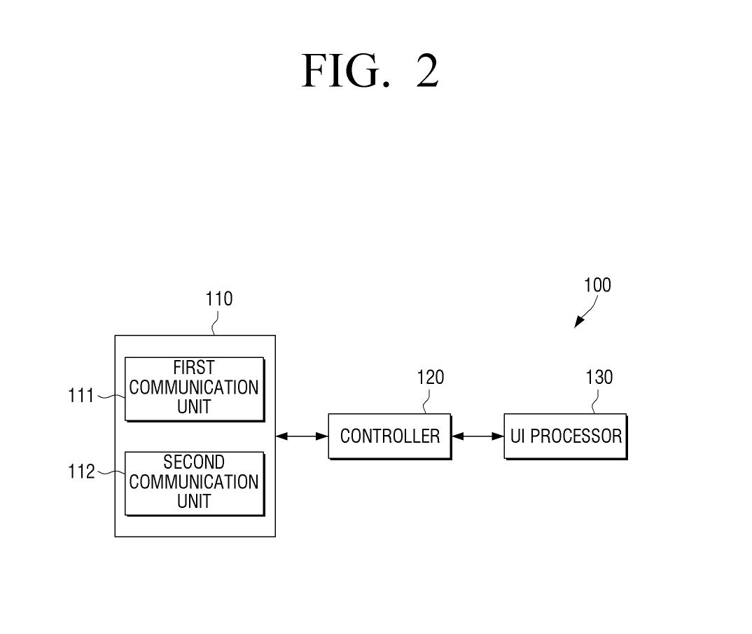

FIG. 2 is a block diagram illustrating a structure of a mobile device 100 according to an exemplary embodiment of the present general inventive concept. As noted earlier, the mobile device 100 may be embodied as various devices such as for example a mobile phone, a smart phone, a tablet PC, a laptop PC, a Personal Digital Assistant (PDA), an MP3 Player, etc. As illustrated in FIG. 2, the mobile device 100 includes a communication unit 110, a controller 120, and a UI processor 130.

The communication unit 110 is a configuration to communicate with a plurality of image forming devices 200. According to an exemplary embodiment of the present general inventive concept, the communication unit 110 may be configured variously. FIG. 2 illustrates the communication unit 110 which is equipped with a first communication unit 111 to perform Near Field Frequency Communication (NFC) and a second communication unit 112 to perform wireless communication outside of NFC. The second communication unit 112 may perform the communication in various communication methods such as Wi-Fi, Bluetooth, 3rd Generation (3G), 4th Generation (4G), etc.

The UI processor 130 is a component to display various UI screens. The UI processor 130 may include a display panel (not illustrated) and a Graphic Processing Unit (GPU, not illustrated). The display panel may be a touch screen, but not limited thereto. When the display panel is a common panel, i.e., not a touchscreen, the mobile device 100 may further include various buttons. The UI processor 130 may display various UI screens according to button manipulation by a user.

The controller 120 is a configuration of controlling overall operations of the mobile device 100. When communication with the first image forming device 200-1 that is one of a plurality of image forming devices 200 is performed, the controller 120 displays a local UI 300 of the first image forming device 200-1 by controlling the UI processor 130. When the mobile device 100 which includes the first communication unit 111 capable of performing NFC is tagged with the first image forming device 200-1, the controller 120 may receive UI information regarding the first image forming device 200-1. In addition, the controller 120 may control the UI processor 130 to display a local UI 300 based on the received UI information. Hence, the user is able to easily understand the functions of the first image forming device 200-1.

When the second image forming device 200-2 which is connectable to the first image forming device 200-1 is selected from the local UI 300, the controller 120 may generate an additional function which is available when the first image forming device 200-1 and the second image forming device 200-2 operate with each other. For example, when the first image forming device 200-1 is a printer and the second image forming device 200-2 is a scanner, the controller 120 may generate a copy function as an additional function. When the additional function is generated, the controller 120 may control the UI processor 130 to display a virtual UI 500 including an additional menu object corresponding to the additional function.

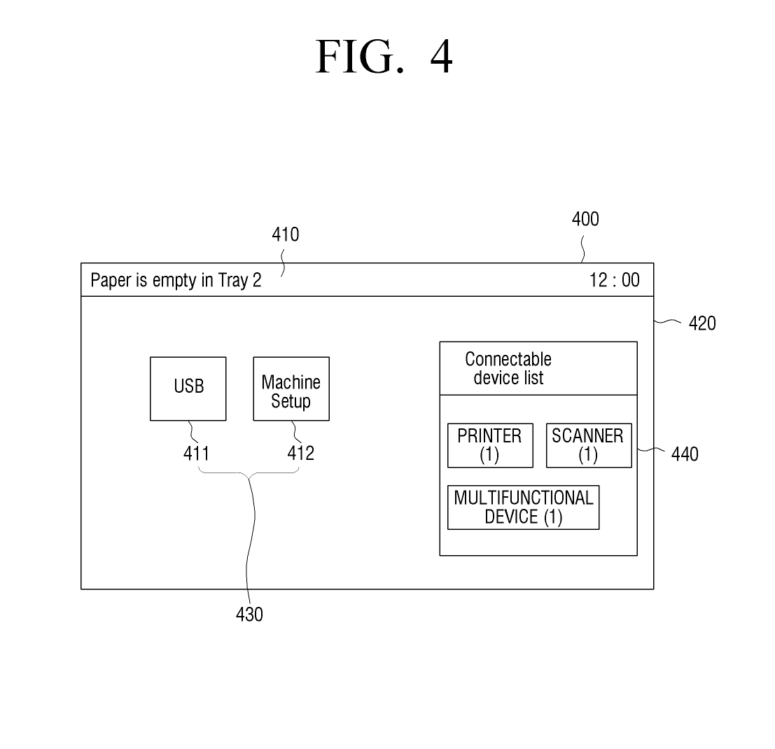

FIGS. 3 and 4 are diagrams illustrating an example of a local UI 300 and 400, respectively.

FIG. 3 illustrates a configuration example of a local UI 300 which is displayed by the UI processor 130 when the mobile device 100 is tagged with a scanner. As illustrated in FIG. 3, a local UI 300 may include an information display area 310 and a menu display area 320.

The information display area 310 may display status information or error information on the first image forming device 200-1, which for the purposes of the exemplary embodiment illustrated in FIG. 3 is a scanner. The menu display area 320 may display a local menu 330 of the first image forming device 200-1, a list 340 regarding devices which are connectable to the first image forming device 200-1, etc.

FIG. 3 illustrates a status where the status information informing that an automatic document feeder (ADF) door of the scanner is open is displayed in the information display area 310. The UI processor 130 may render various information, the local menu 330, and the list 340 on a screen according to UI information provided by the first image forming device 200-1.

The local menu 330 includes objects 331 to 334 which correspond to various functions that the first image forming device 200-1 may perform autonomously. Although FIG. 3 illustrates each object which is displayed in a form of icon, the form of the icons is not limited thereto, and each object may be displayed in a form of text or images which correspond to a name of each function.

The list 340 displays the objects corresponding to various devices capable of performing the image forming job by being connected to the scanner. Although FIG. 3 illustrates a status where icons for other image forming devices 200 than the first image forming device 200-1, for example a scanner, the status does not need to be displayed as icon, and may be displayed in a form of various objects. The objects may be for example text or images. The exemplary embodiment illustrated in FIG. 3 displays the image forming devices 200 illustrated in FIG. 1, in this case two printers and a multifunctional device. Since the scanner illustrated in FIG. 1 is selected as a first image forming device 200-1, the scanner is not included in the list 340. Furthermore, the list 340 may include identifiers to further distinguish the image forming devices 200 from each other. In FIG. 3, for example, the printers and scanners include numbers (1), (2), etc. However, it will be understood that the identifiers may take any form which will help a user distinguish the image forming devices 200 from each other. For example, the printers could be identified with names such as “Office Printer,” “Desk Printer,” etc.

FIG. 4 illustrates an example of a local UI 400 which is displayed when the mobile device 100 is tagged with a printer as the first image forming device 200-1. In this case, the information display area 410 of the local UI 400 displays the status information or error information on the printer 200-1. FIG. 4 illustrates a status where information that informs a paper run-out status of a tray 2 of the printer 200-1 is displayed.

A menu display area 420 may display a local menu 430. In addition, the local menu 430 may be changed from local menu 330 to include local menu objects 411 and 412 regarding the functions of the printer 200-1, and the list 440 of connectable devices is changed from list 340 so as to include the scanner and no longer include the printer that is selected as the first image forming device 200-1.

In this state, when a user selects one of the devices included in the list, the controller 120 of the mobile device 100 may generate additional functions which may be provided when the selected device, that is, the second image forming device 200-2, operates with the previously selected device, that is, the first image forming device 200-1. The controller 120 displays a virtual UI 500 including additional menu objects corresponding to the additional functions by controlling the UI processor 130.

FIG. 5 is a diagram illustrating an example of a virtual UI 500 which is generated when a printer is selected while a local UI 300 of a scanner is displayed in the mobile device 100. The controller 120 may add one or more new functions which are executable when the scanner and the printer operate with each other.

For example, the controller 120 may generate a new copy function, corresponding to generating scan data through a scanning job of the scanner and outputting the scan data by using the printer. The UI processor 130 generates a new copy menu object 521 corresponding to the copy function. When the printer includes a USB port, the controller 120 may further generate a scan to USB function of storing the scan data in a USB memory, a USB function of accessing to the data stored in the USB memory, etc. In this case, as illustrated in FIG. 5, the UI processor 130 generates a new USB menu object 522, a scan to USB menu object 523, etc. The UI processor 130 further displays new menu objects 521, 522, and 523 in addition to the existing menu objects, that is, the local menu objects 331 to 334. For convenience in explanation, a UI screen where a new function is added is called a virtual UI 500 herein. “Virtual UI” signifies a UI screen which is randomly generated by the mobile device 100, and the virtual UI 500 may be called differently as various names such as a complex UI, a network UI, etc. The UI processor 120 may further generate a local UI menu object 524 to return to the local UI 300 and display the local UI menu object 524 in the virtual UI in addition to the other displayed menu objects. When the additional menu objects are generated, the UI processor 120 may rearrange and display the existing local objects and the additional menu objects together on the virtual UI.

Meanwhile, although FIGS. 3 to 5 illustrate a UI screen whose horizontal length is longer than its vertical length, the configuration of the UI screen may be changed variously depending upon the particular exemplary embodiment of the present general inventive concept, for example depending upon a type of the mobile device 100. In addition, the information display area may not be provided in a local UI 300, and in this case, the information may be displayed in various methods.

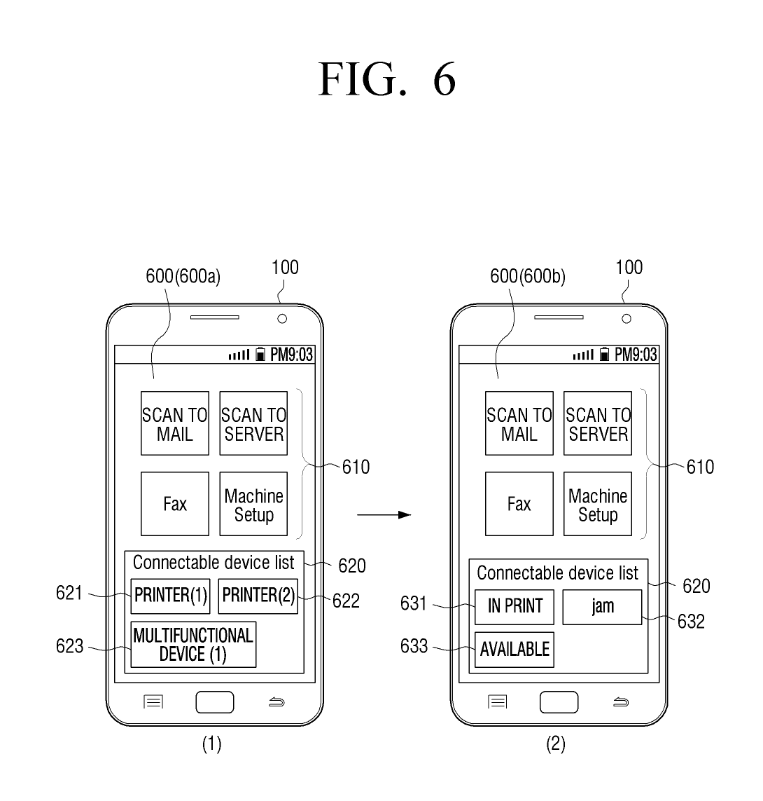

FIG. 6 is a diagram illustrating an example of a UI configuration whose vertical length is longer than its horizontal length, according to an exemplary embodiment of the present general inventive concept. As illustrated in FIG. 6, a local UI 600 may include an existing menu display area 610 and a list display area 620. The list display area 620 may display icons or other identifiers 621, 622, and 623 corresponding to other connectable image forming devices 200.

The controller 120 may control the UI processor 130 so as to display a message corresponding to at least one of the capability information, the status information, and the error information provided by other image forming devices 200 while toggling the message with an icon. The message may be displayed in a form of icon or text.

FIG. 6 view (1) illustrates a status where icons 621, 622 and 623 are displayed on the list display area 620 and FIG. 6 view (2) illustrates a status where messages 631, 632, and 633 are displayed. The screens 600a and 600b respectively illustrated in FIG. 6 views (1) and (2) may be alternately toggled with each other. That is, the icons 621-623 and messages 631-633 may be alternately displayed at predetermined intervals, to identify the image forming devices 200 and their respective statuses. Through the UI screen illustrated in FIG. 6, a user is able to easily recognize that the printer 200-1 is being used, a printer (2) 200-2 is in a jam status, and a multifunctional device 200-4 is available. When the capability information is displayed, the user may easily recognize a device which has a desired function through a message 631-633.

In the exemplary embodiment of the present general inventive concept as in FIG. 6, the mobile device 100 should receive the capability information, the status information, and the error information on other image forming devices 200 before configuring the local UI 600, but is not limited thereto.

For example, when the second image forming device 200-2 is selected from among the other image forming devices 200 displayed in a list of the local UI 600, the controller 120 may request for at least one of the capability information, the status information, and the error information to the second image forming device 200-2, and receive the information. In this case, other communications methods such as Wi-Fi, Bluetooth, and Zigbee except for NFC may be used. When the capability information, the status information, and the error information are received, the controller 120 may control the UI processor 120 to configure a virtual UI 500 based on the received capability information and display the status information or the error information in the virtual UI 500.

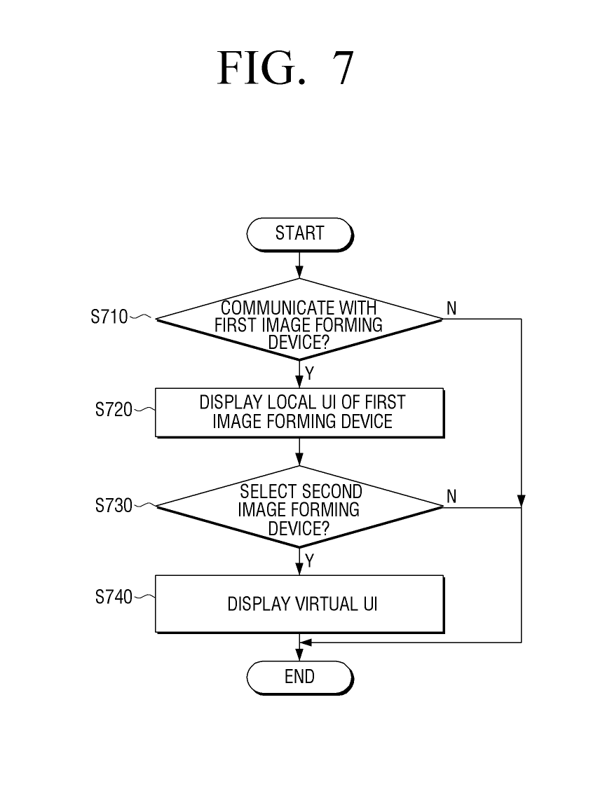

FIG. 7 is a flow chart describing a method of controlling an image forming device 200 connected to a mobile device 100 according to an exemplary embodiment of the present general inventive concept. As illustrated in FIG. 7, when communication with the first image forming device 200-1 is performed (operation S710-Y), the mobile device 100 displays a local UI of the first image forming device 200-1 (operation S720). When communication with the first image forming device 200-1 is not performed (operation S710-N), the method may end.

When the second image forming device 200-2 is selected from the local UI (operation S730-Y), the mobile device 100 displays a virtual UI 500 (operation S740). The configuration examples and displaying methods of the local UI and the virtual UI 500 were described above in the aforementioned various exemplary embodiments of the present general inventive concept, and thus, the overlapped description is omitted. If the second image forming device 200-2 is not selected from the local UI (operation S730-N), the method may end.

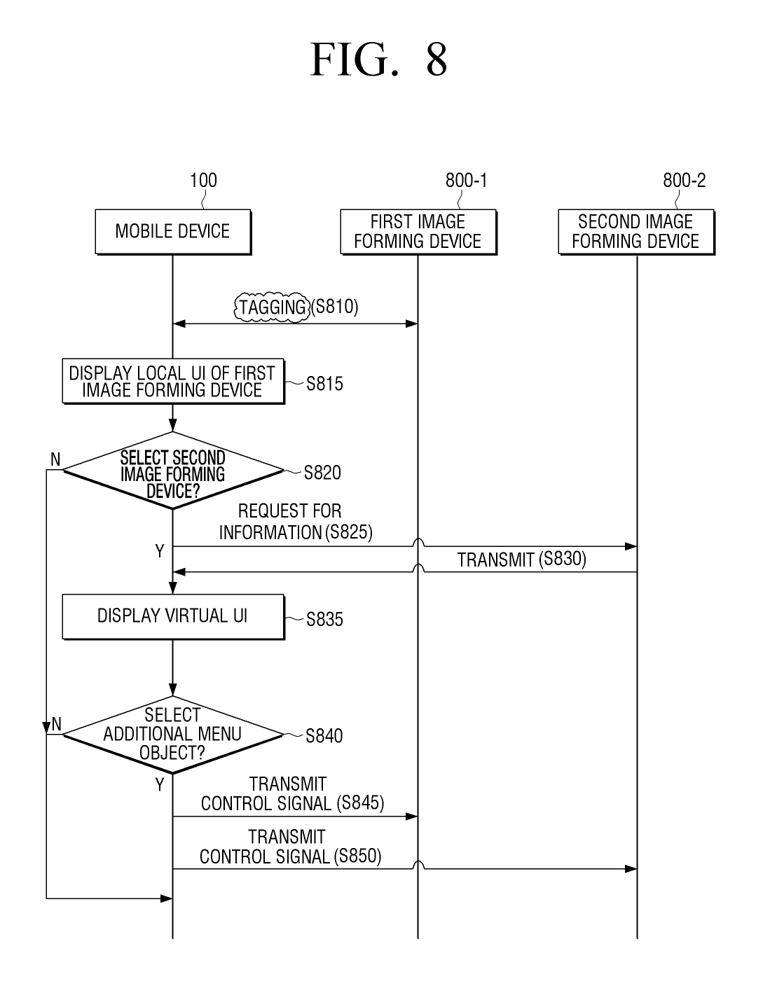

FIG. 8 is a timing diagram describing a method to display a UI of an image forming system according to an exemplary embodiment of the present general inventive concept. The image forming system may include a plurality of image forming devices 800, which may be similar in configuration to the image forming devices 200 described above. As illustrated in FIG. 8, when the mobile device 100 is tagged with the first image forming device 800-1 that is one of the plurality of image forming devices 800 (operation S810), the mobile device 100 performs NFC and receives various information. To be specific, the mobile device 100 may receive the UI information to configure a local UI of the first image forming device 800-1, the capability information, the status information, and the error information on the first image forming device 800-1, address information, identification information, and location information on other image forming devices 800 which are connectable to the first image forming device 800-1, etc. The first image forming device 800-1 may include a wired or wireless connection capability, including for example USB, LAN, Wi-Fi, Bluetooth, NFC, or a wireless AP.

The mobile device 100 displays the local UI of the first image forming device 800-1 based on the received information (operation S815). The local UI may include information showing the operation status or error status of the first image forming device 800-1, a local menu, and information on other image forming devices 800. The information on other image forming devices 800 may include identification information, address information, and location information on the other image forming devices 800.

When another image forming device 800, that is, the second image forming device 800-2 is selected from the local UI (operation S820-Y), the mobile device 100 accesses the selected second image forming device 800-2 and requests detailed information (operation S825). To be specific, the mobile device 100 may request for various information such as the capability information, the status information, and the error information to the second image forming device 200-2. The second image forming device 800-2 may transmit various detailed information in response to the request (operation S830). Alternatively, if the second image forming device 800-2 is not selected from the local UI (operation S820-N), the local UI, the method may end.

Although FIG. 8 illustrates the mobile device 100 communicating directly with the second image forming device 800-2, it will be understood that the mobile device may also communicate indirectly with the second image forming device 800-2 through the first image forming device 800-1, which is connected to the second image forming device 800-2. Depending on the method of communication, the second image forming device 800-2 may include wired or wireless capabilities noted above with respect to the first image forming device 800-1.

When the detailed information is received from the second image forming device 800-2, the mobile device 100 displays a virtual UI 500 based on the received detailed information (operation S835). To be specific, the mobile device 100 may generate additional functions which are executable when the first image forming device 800-1 and the second image forming device 800-2 operate with each other and generate additional menu objects corresponding to the additional functions. The mobile device 100 may configure a virtual UI 500 by adding the generated additional menu objects to the existing local menu objects. The virtual UI 500 may display an operation status or error status of the first image forming device 800-1 or the second image forming device 800-2.

If the user does not select an additional menu object (operation S840-N), the method may end. When the user selects an additional menu object (operation S840-Y), the mobile device 100 transmits a control signal to each of the first image forming device 800-1 and the second image forming device 800-2 (operations S845 and S850). For example, when the user selects the copy menu object 521 in a state where the virtual UI 500 in FIG. 5 is displayed, the mobile device 100 may transmit a first control signal to generate scan data by performing a scanning job and transmitting the scan data to the second image forming device 800-2 to the first image forming device 800-1, and transmit a second control signal to receive and print out the scan data to the second image forming device 800-2 (operation S850). Alternatively, when the user selects the scan to USB menu object 523, the mobile device 100 may transmit the first control signal to generate scan data by performing a scanning job and transmitting the scan data to the second image forming device 800-2 to the first image forming device 800-1 (operation S845), and transmit the second control signal to receive and store the scan data in a USB memory to the second image forming device 800-2 (operation S850).

In FIG. 8, although it was described that the capability information, the status information, and the error information are requested to the second image forming device 800-2 when the second image forming device 800-2 is selected from the local UI, the requested operation may be performed in a different order according to other exemplary embodiments of the present general inventive concept. For example, when the first image forming device 800-1 already has the capability information, the status information, and the error information on the second image forming device 800-2, the mobile device 100 may receive the information of the second image forming device 800-2 as well when the mobile device 100 is tagged with the first image forming device 800-1.

In addition, in FIG. 8, it was described that the local UI of the first image forming device 800-1 is displayed when the mobile device 100 is tagged with the first image forming device 800-1, but not limited thereto. That is, according to another exemplary embodiment of the present general inventive concept, when a user manipulation to perform an image forming job is made, the mobile device 100 may search nearby image forming devices 800, and display a list of the searched image forming devices 800. In this case, the user is able to select the first image forming device 800-1 from the displayed list. The mobile device 100 may request for various information such as the UI information, the capability information, the status information, and the error information from the selected first image forming device 800-1, receive the information, and display a local UI based on the received information.

According to another exemplary embodiment of the present general inventive concept, when the user manipulation to perform an image forming job is performed, the mobile device 100 may search the nearby image forming devices, and request the capability information, the status information, and the error information to each of the searched nearby image forming devices 800. When the information on each device is received, the mobile device 100 may generate a virtual UI 500 based on the received information.

Meanwhile, various exemplary embodiments of displaying a UI to control the operations of the image forming devices 800 in the mobile device 100 were described above, but according to another exemplary embodiment of the present general inventive concept, a virtual UI 500 may be displayed through transmission of information between the image forming devices 800 without involvement of the mobile device 100.

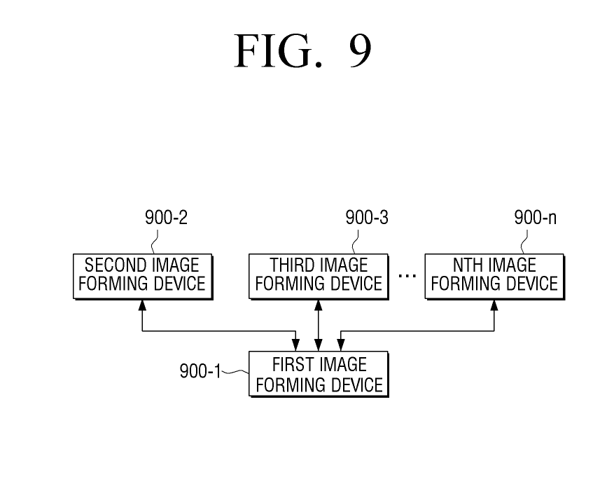

FIG. 9 is a block diagram describing a structure of an image forming system according to another exemplary embodiment of the present general inventive concept. As illustrated in FIG. 9, the image forming system may include a plurality of image forming devices 900-1 to 900-n, corresponding to first to nth image forming devices 900, which are connected to each other through the network. The image forming devices 900 may be similar in construction and capabilities to the image forming devices 200 and 800 described above.

Hereinafter, it is assumed that a first image forming device 900-1 that is one of the plurality of image forming devices 900-1 to 900-n is an operation subject.

The first image forming device 900-1 displays a local UI in a stand-by status. The first image forming device 900-1 may transmit a query signal to search other image forming devices 900 on the network periodically or at a predetermined time interval according to occurrence of a particular event, for example in response to a user input on the displayed local UI. When a response signal corresponding to the query signal is transmitted, the first image forming device 200-1 recognizes other image forming devices 900 which transmitted the response signal as connectable devices, and displays a list of connectable devices in the local UI.

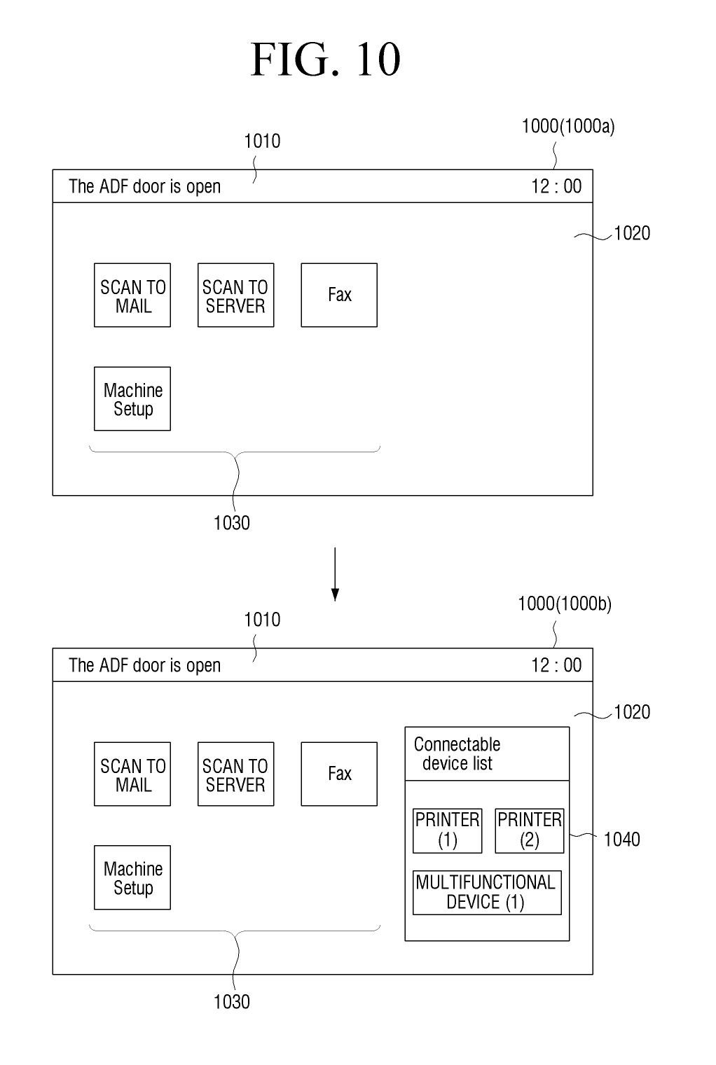

FIG. 10 is a diagram describing a change of a local UI 1000 according to a connection relation of an image forming device according to an exemplary embodiment of the present general inventive concept. The local UI 1000 may correspond to the image forming system including a plurality of image forming devices 900 illustrated in FIG. 9. As illustrated in FIG. 10 view (1), when a connectable device is not searched, the first image forming device 900-1 displays a local UI 1000a including an information display area 1010 and a local menu area 1020 including a local menu 1030. When other image forming devices 900 are searched in this state, the first image forming device 900-1 displays a list 1040 of connectable devices in a local UI 1000b additionally, as illustrated in FIG. 10 view (2). The user is able to select one of the other image forming devices 900 from the list 1040 displayed in the local UI 1000b.

When the user selects one of the other image forming devices 900, the first image forming device 900-1 may request the capability information, the status information, and the error information from the selected other image forming device 900 and receive the information.

When the information is received, the first image forming device 900-1 may generate additional functions based on the received information, and display a virtual UI 500 including additional menu objects corresponding to the generated additional functions.

The user is able to select an additional menu object from the virtual UI 500. When the additional menu object is selected, the first image forming device 900-1 may transmit a control signal for an operation which is necessary to execute the additional function corresponding to the selected additional menu object to another image forming device 900. By doing so, it becomes possible to provide a function which may not be provided by solely the first image forming device 900-1 though the interwork of a plurality of image forming devices 900.

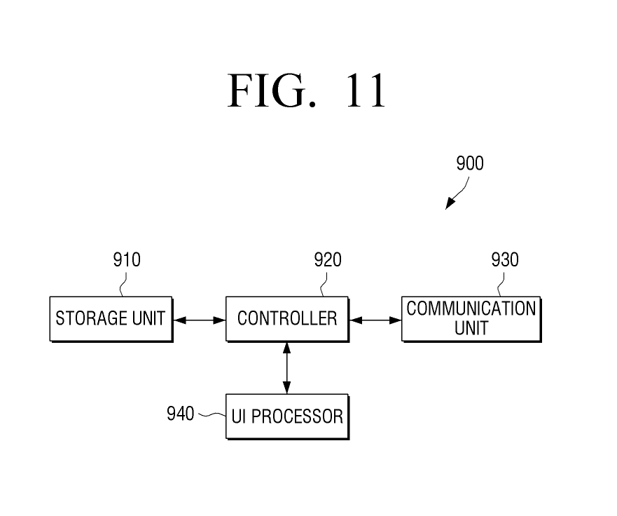

FIG. 11 is a block diagram illustrating an example of a structure of the image forming device 900 according to an exemplary embodiment of the present general inventive concept. As illustrated in FIG. 11, the image forming device 900 may include a storage unit 910, a controller 920, a communication unit 930, and a UI processor 940.

The storage unit 910 may store various programs and data. To be specific, the storage unit 910 may store a plurality of function modules. A function module corresponds to a program to perform various functions such as an automatic paper feeding function to perform an automatic paper feeding operation, a binding function, a document sorting function, a mail forwarding function, an alarm function, a job execution reserving function, and the like as well as basic image forming jobs such as printing, scanning, transmitting facsimile, copying, etc.

The storage unit 910 may store only function modules which are executable in the image forming device 900, or may store a plurality of function modules and selectively activate and use the functions modules which are executable according to the hardware specification and the software specification of the image forming device 900 and any other devices connected thereto.

The UI processor 940 generates and displays a local UI of the image forming device 900, which is referred to herein as the first image forming device 900-1. The local UI may include at least one local menu and a connection menu to operate with other image forming devices 900, which respectively correspond to each of at least one function module executable in the first image forming device 900-1. In addition, as described above in connection with FIGS. 3, 4, and 6, the local UI may further include an area which displays the status information or error information on the first image forming device 900-1.

When another image forming device 900, herein referred to as a second image forming device 900-2, is not connected, the controller 920 may control the UI processor 940 to display a local UI including only a local menu 1030 as illustrated in FIG. 10. When the second image forming device 900-2 is connected, the controller 920 may control the UI processor 940 to generate a connection menu corresponding to the connected second image forming device 900-2 and add the connection menu to the local UI 1000.

The communication unit 930 is a configuration to communicate with second image forming device 900-2. To be specific, when a user selects a connection menu from a local UI, the communication unit 930 connects communication with the selected second image forming device 900-2. The communication unit 930 may receive the capability information, the status information, and the error information from the second image forming device 900-2 sequentially or in a lump sum.

When the communication with the second image forming device 900-2 is connected, the controller 920 may generate an additional function which may be provided when the first image forming device 900-1 and the second image forming device 900-2 operate with each other. To be specific, the controller 920 may select an additional function by combining capability information received through the communication unit 930 and capability information that the image forming devices 900-1 and 900-2 have. The combination relation of the capability information may be determined based on a database which was preset and stored in the storage unit 910. For example, a manufacturer or a program developer of the first image forming device 900-1 may generate and store a database in the storage unit 910 beforehand which is set to generate a copy function by combining a scan function and a print function and generate a facsimile to mail function by combining a facsimile receiving function and an e-mail forwarding function. The controller 920 may generate an additional function based on such database. The controller 920 may select a function module corresponding to the generated additional function from among the function modules stored in the storage unit 910, and additionally activate the selected function module. Alternatively, the controller 920 may download an application corresponding to the additional function from an external server (not illustrated) or another image forming device 900, for example the second image forming device 900-2. The controller 920 may activate the additional function by installing the downloaded application in the storage unit 910.

When the additional function is generated, the controller 920 controls the UI processor 940 to display a virtual UI 500 including an additional menu object corresponding to the additional function and a local menu 1030.

As specified above, when the status information and the error information are received through the communication unit 930, the controller 920 may control the UI processor 940 to display the status information or the error information. The status information or the error information may be displayed in an area within the local UI, or may be displayed in a form of message which is toggled with an icon. That is, both the status information and the error information may be displayed alternately at predetermined intervals.

When the additional menu object is selected from the virtual UI 500, the controller 920 may execute the additional function by transmitting a control signal to the second image forming device 900-2 to operate together with the first image forming device 900-1. For example, when the first image forming device 900-1 is a scanner, the second image forming device 900-2 is a printer, and a user selects a copy menu object from among the additional menu objects, the controller 920 may perform a scanning job by controlling a scanner unit included in the image forming device 900, and transmit the scan data and a printer command to the printer so that the printer prints out the scan data. Hence, the first image forming device 900-1 may support the additional function that the first image forming device 900-1 does not normally support, that is, a copy function.

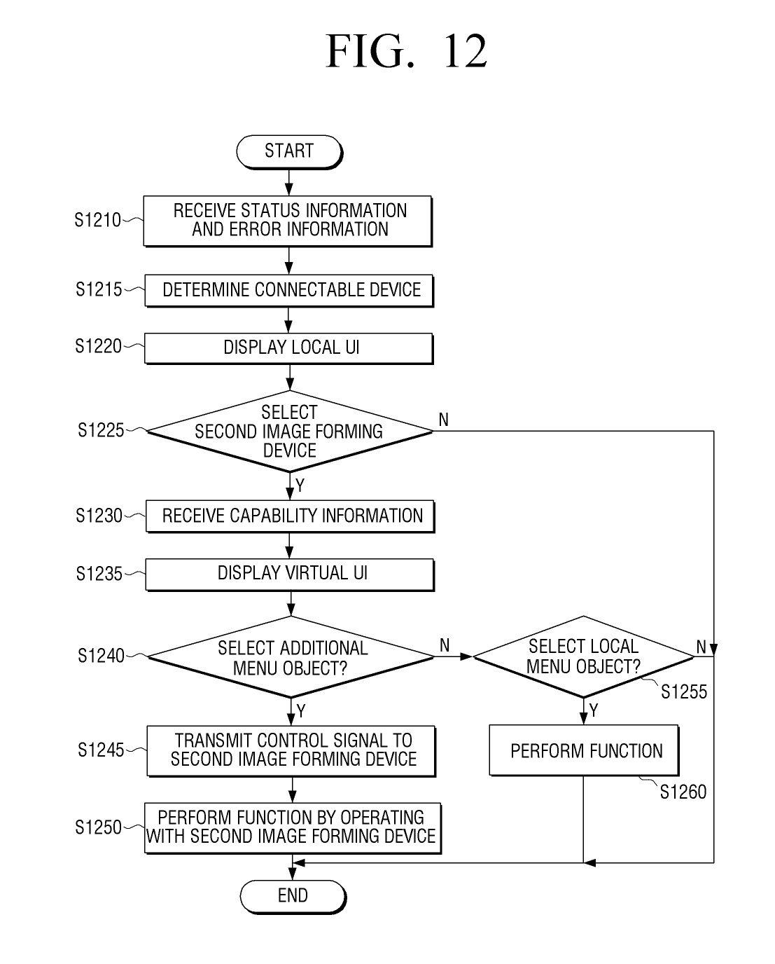

FIG. 12 is a flow chart describing a method to display a UI of an image forming device 900 according to an exemplary embodiment of the present general inventive concept. As illustrated in FIG. 12, the image forming device 900 (first image forming device 900-1) receives the status information and error information from the nearby image forming devices 200 (operation S1210). The first image forming device 900-1 may determine connectable devices based on the received status information and the error information (operation S1215).

When the connectable devices are determined, the first image forming device 900-1 displays a local UI including a connection menu for the determined devices and a local menu 1030 that the first image forming device 900-1 may autonomously support (operation S1220). The user is able to select the connection menu from the local UI.

If a second image forming device 900-2 is not selected (operation S1225-N), the method may end. When a second image forming device 900-2 is selected (operation S1225-Y), the first image forming device 900-1 receives the capability information on the second image forming device 900-2 (operation S1230). The first image forming device 900-1 generates an additional function which is executable when the first image forming device 900-1 operates with the second image forming device 900-2, and displays a virtual UI 500 including additional menu objects corresponding to the additional functions (operation S1235).

When one of the additional menu objects is selected from the virtual UI 500 (operation S1240-Y), the first image forming device 200-1 transmits a control signal to the second device (operation S1245). Hence, the first image forming device 900-1 may perform the additional functions by operating with the second image forming device 900-2 (operation S1250).

Meanwhile, the virtual UI 500 may include the local UI. When one of the additional menu objects is not selected (operation 1240-N) and one of the local menu objects is selected (operation S1255-Y), the first image forming device 900-1 performs a function corresponding to the selected local menu object autonomously (operation S1260). If one of the additional menus is not selected (operation 1240-N) and the local menu object is also not selected (operation S1255-N), the method may end.

As specified above, according to an exemplary embodiment of the present general inventive concept, the user is able to use various functions which may be provided when the first image forming device 900-1 operates with second image forming device 900-2 by using a virtual UI 500 displayed in a single image forming device, such as the first image forming device 900-1.

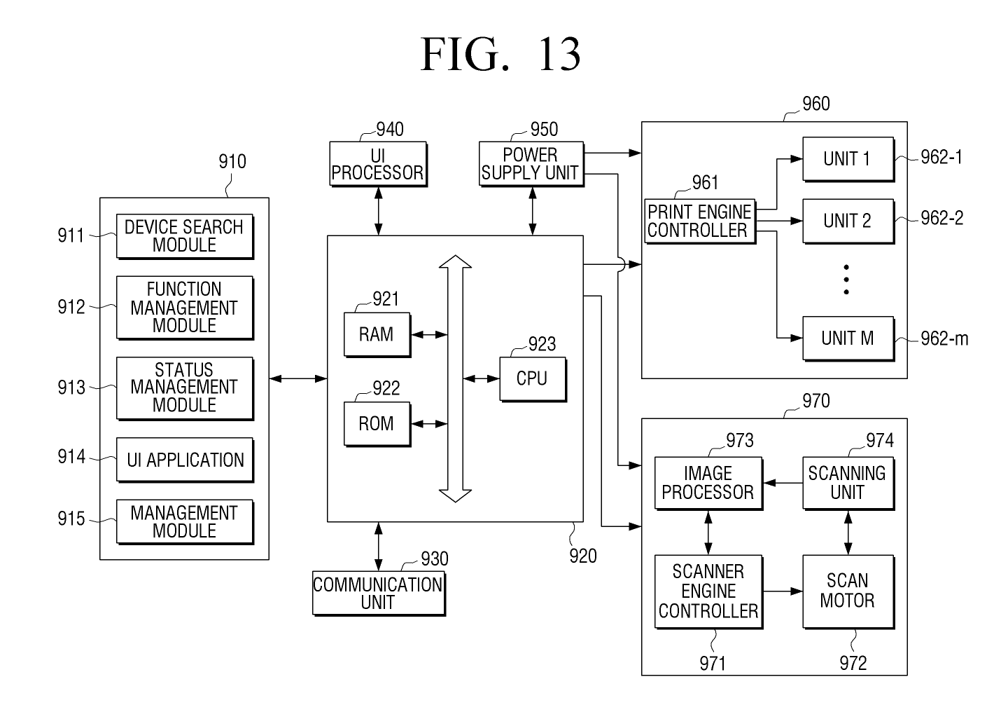

FIG. 13 is a block diagram describing specific configurations of an image forming device which is embodied as a multifunctional device having multiple image forming functions. The image forming device illustrated in FIG. 13 may correspond to the image forming device 900 illustrated in FIG. 9. As illustrated in FIG. 13, the image forming device 900 includes the storage unit 910, the controller 920, the communication unit 930, the UI processor 940, a power supply unit 950, a printer 960, and a scanner 970.

The construction and operations of the storage unit 910, the controller 920, the communication unit 930, and the UI processor 940, are described above with respect to the aforementioned exemplary embodiments of the present general inventive concept, and so are not repeated herein.

The storage unit 910 may store various function blocks and software modules 911 to 915. The controller 920 may perform various operations by executing the software modules 911 to 915 and the functions blocks stored in the storage unit 910.

The controller 920 may include a Random Access Memory (RAM) 921, a Read-Only Memory (ROM) 922, and a Central Processing Unit (CPU) 923. The CPU 923 may control the operations of the image forming device 900 by using various programs stored in the storage unit 910. For example, when power is turned on, the CPU accesses to the storage unit 910 and performs booting by using an operating system (O/S) stored in the storage unit 910.

The ROM 922 stores a command set to boot a system. When a turn-on command is input and power is supplied, the CPU 923 copies the O/S stored in the storage unit 910 into the RAM 921 according to the command stored in the ROM 922, and boots the system by executing the O/S. When the booting is completed, the CPU 923 copies various programs stored in the storage unit 910 into the RAM 921, and performs various operations by executing the programs which are copied into the RAM 921.

To be specific, the CPU 923 copies a device search module 911, a function management module 912, a status management module 913, a UI application 914, and a management module 915 into the RAM 921, and executes the modules respectively. The device search module 911 searches other image forming devices 900 which are connectable to the image forming device 900 and configures the search result in a form of list. The function management module 912 generates a UI option such as a local menu 1030 and an additional menu object based on information regarding activated function blocks among the function blocks in the storage unit 910 and the capability information received from the other image forming devices 900. The status management module 913 generates various messages based on the status and the error information on the image forming device 900 and the status information and the error information on other image forming devices 900. The UI application 914 generates a local UI or a virtual UI 500 including a list generated by the device search module 911, the function management module 912, and the status management module 913, an UI option, a status message, and an error message, and provides the UI processor 940 with the local UI or the virtual UI 500. The UI processor 940 displays the generated UI screen. The management module 915 generates additional functions by combining the capability information on the connectable devices and performs management operations such as an installation or deletion of an application.

Besides, the controller 920 controls the entire set of the image forming device 900 according to data and commands transmitted from an external device which is connected through the communication unit 930 and a user select command which is input through the UI processor 940.

To be specific, when a print command is executed in a printer driver or an application installed in a host PC, the printer driver of the host PC generates print data where a document is converted into a certain printer language. The controller 920 may receive the print data through the communication unit 930. The controller 920 may convert the print data into a bitmap image consisting of 0 and 1 by using a Halftone Table and provide the printer 960 with the bitmap image to output the image on paper.

The printer 960 may include a print engine controller 961 and a plurality of units 962-1 to 962-m which are applied to a printing job. In case of a laser printer, the units 962-1 to 962-m may include a feeding unit, a charging unit, an exposing unit, a developing unit, a transferring unit, a fixing unit, a discharging unit, etc. In case of an inkjet printer, the units 962-1 to 962-m may include a feeding unit, an inkjet printer head, an ink cartridge, a discharging unit, etc. The print engine controller 961 performs a printing job of the bitmap image provided by the controller 920 by controlling the units 962-1 to 962-m.

Meanwhile, when a scan command is input through the UI processor 940, the controller 920 may perform a scanning job by controlling the scanner 970.

The scanner 970 includes a scanner engine controller 971, a scan motor 972, an image processor 973, and a scanning unit 974.

When a scan command is transmitted from the controller 920, the scanner engine controller 971 operates the scanning unit 974 and the scan motor 972 to scan a subject, and controls the image processor 973 to generate scan data.

The scan motor 972 moves the scanning unit 974 or papers so that the entire subject is scanned. That is, the scan motor 972 moves a different medium depending upon an operating method of the scanner, that is, whether the operating method is a sheet-feed method or a flatbed method. For example, in case of sheet-feed scanner, the scan motor 972 moves the papers, and in case of flatbed scanner, moves the scanning unit 974. The scan motor 972 may be embodied as a Carriage Return Motor and the like.

The scanning unit 974 scans a subject. The scanning unit 974 may include an image scanning sensor, a lens, and a light source, and a Charge-Coupled Device (CCD) or CompuServe Information Service (CIS) image sensor is commonly used as the image scanning sensor. The image scanning sensor may include a photoelectric converter (not illustrated) configured to generate electric charge by absorbing a reflected light of a light which is generated from a light source (not illustrated) and irradiated to a subject, and a signal detector (not illustrated) configured to detect the electrical charge generated in the photoelectric converter and convert the detected electrical charge into an electrical signal. The electrical signal converted by the signal detector is provided to the image processor 973.

The image processor 973 performs processing jobs such as shading, gamma correction, Dot Per Inch (DPI) conversion, edge emphasis, error diffusion, scaling, and the like with respect to image data which is input from the scanning unit 974 thereby generating scan data. In this case, the image processor 973 processes the scan data appropriately considering a predetermined resolution, scan mode, scan area, expansion and reduction ratio, etc. The scan data which is generated by the image processor 973 is stored in the storage unit 910.

The power supply unit 950 supplies power to each component within the image forming device 200. To be specific, the power supply unit 950 may receive alternating current input (AC_IN) from an external source, and convert and output the AC into direct current (DC_OUT) in a potential level which is suitable for each component by using elements such as a transformer, an inverter, a rectifier, etc.

As described above, FIG. 13 illustrates an example of a multifunctional device having a printing function and a scanning function. Some configuration may be omitted when the image forming device 900 is embodied as a printer or a scanner. In addition, although not illustrated in FIG. 13, the image forming device 900 may further include configurations such as bus to exchange data between the components and buffer to temporarily store data. The image forming device 900 may include other image forming functions as well, such as a facsimile function.

The image forming devices 200 and 800 described in the aforementioned various exemplary embodiments of the present general inventive concept may be embodied as the image forming device 900 illustrated in FIG. 13.

According to the aforementioned various exemplary embodiments of the present general inventive concept, a user is able to control a plurality of image forming devices by using a mobile device or an image forming device. Hence, the user is able to perform an image forming job more conveniently and efficiently

In addition, according to the aforementioned various exemplary embodiments of the present general inventive concept, a user is able to intuitively understand devices which may be connected and functions which may become available when the devices are connected. In addition, the image forming device may provide menus to control devices which may operate with each other in a form of application, and display the status information and error information on each device through a UI thereby displaying a device status before and after the connection. In addition, the image forming device may delete an icon for an application of a device which is connectable but not used in the local UI thereby increasing the usability.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

To be specific, as to a mobile device, a non-transitory computer readable medium may include a program code to sequentially perform, when communication with the first image forming device that is one of a plurality of image forming devices is performed, displaying a local UI of the first image forming device, when a second image forming device which is connectable to the first image forming device is selected from the local UI, generating additional functions which may be provided when the first image forming device and the second image forming device operate with each other, and displaying a virtual UI including additional menu objects corresponding to the additional functions may be used.

As for an image forming device, a non-transitory computer readable medium including a program code to perform displaying a local UI including a local menu and a connection menu, when the connection menu is selected from the local UI, generating additional functions based on the capability information on other image forming device corresponding to the selected connection menu, and displaying a virtual UI including additional menu objects corresponding to the additional functions and the local menu may be used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A mobile device comprising:
a communication unit configured to communicate with a plurality of image forming devices;
a user interface (UI) processor configured to, when communication with a first image forming device that is one of the plurality of image forming devices is performed, display a local UI of the first image forming device; and
a controller configured to, when a second image forming device which is connectable to the first image forming device is selected from the local UI, generate an additional function which is providable when the first image forming device and the second image forming device operate with each other, and control the UI processor to display a virtual UI including an additional menu object corresponding to the additional function.

2. The mobile device of claim 1, wherein when the additional menu object is selected from the virtual UI, the controller executes the additional function by transmitting a control signal to each of the first image forming device and the second image forming device.

3. The mobile device of claim 2, wherein the local UI includes a local menu object corresponding to a function which is autonomously providable by the first image forming device and a list of other image forming devices which are connectable to the first image forming device.

4. The mobile device of claim 3, wherein when the second image forming device is selected from among the other image forming devices displayed in the list, the controller requests capability information, status information, and error information from the second image forming device.

5. The mobile device of claim 4, wherein:
the list includes icons corresponding to each of the other image forming devices; and
when the capability information, the status information, and the error information are received from the second image forming device, the UI processor displays a message corresponding to at least one of the capability information, the status information, and the error information while toggling the message with the corresponding icon.

6. The mobile device of claim 4, wherein:
the communication unit comprises:
a first communication unit configured to perform near field frequency communication; and
a second communication unit; and
when the near field frequency communication between the first communication unit and the first image forming device is performed and UI information on the first image forming device is received, the controller controls the UI processor to generate the local UI according to the UI information, and when the second image forming device is selected from the list, requests the capability information, the status information, and the error information to the second image forming device by using the second communication unit.

7. A method of controlling an image forming device connected to a mobile device, the method comprising:
when communication with a first image forming device that is one of a plurality of image forming devices is performed, displaying a local UI of the first image forming device;
when a second image forming device which is connectable to the first image forming device is selected from the local UI, generating an additional function which is providable when the first image forming device and the second image forming device operate with each other; and
displaying a virtual UI including an additional menu object corresponding to the additional function.

8. The method of claim 7, further comprising:
when the additional menu object is selected from the virtual UI, executing the additional function by transmitting a control signal to each of the first image forming device and the second image forming device.

9. The method of claim 8, wherein the local UI includes a local menu object corresponding to a function which is autonomously providable by the first image forming device and a list of other image forming devices which are connectable to the first image forming device.

10. The method of claim 9, wherein when the second image forming device is selected from among the other image forming devices included in the list, the displaying the virtual UI comprises generating the virtual UI based on the capability information, the status information, and the error information on the second image forming device; and
displaying the generated virtual UI.

11. The method of claim 10, wherein:
the list includes icons corresponding to each of the other image forming devices; and
the method further comprises displaying a message corresponding to at least one of the capability information, the status information, and the error information in the local UI while toggling the message with the corresponding icon.

12. The method of claim 10, further comprising:
when near field frequency communication with the first image forming device is performed and UI information on the first image forming device is received, generating the local UI according to the UI information.

13. A non-transitory computer-readable medium to contain computer-readable codes as a program to execute the method of claim 7.
